(19) United States
(12) Patent Application Publication
(10) Pub. No.: US 2024/0389677 A1
(43) Pub. Date: Nov. 28, 2024

(54) SMOKING SUBSTITUTE SYSTEM

(71) Applicant: Imperial Tobacco Limited, Bristol (GB)

(72) Inventor: Adam Baragwanath, Liverpool Merseyside (GB)

(21) Appl. No.: 18/694,410

(22) PCT Filed: Sep. 8, 2022
(86) PCT No.: PCT/EP2022/074948

§ 371 Date: Mar. 21, 2024

(30) Foreign Application Priority Data
Sep. 27, 2021 (EP) 21199097.3

(51) Int. Cl. A24F 40/85; A24F 40/20; A24F 40/40; B08B 1/16; B08B 1/30

(52) U.S. Cl. CPC A24F 40/85; A24F 40/20; A24F 40/40; B08B 1/165; B08B 1/30

(57) ABSTRACT

The present invention relates to a smoking substitute device and particularly, although not exclusively, to a smoking substitute device that facilitates cleaning. Accordingly, there is provided a smoking substitute device comprising a body (209) having a longitudinal extension, a cavity (222), arranged at an end of the body, for receiving an aerosol-generating consumable (202), a heating element (223) arranged in the cavity and having a longitudinal extension substantially parallel to the longitudinal extension of the body and a removable cap covering the end of the body where the cavity is arranged at, wherein, for detaching the removable cap from the smoking substitute device, the removable cap is arranged to be moved in a first direction (402) and subsequently is arranged to be moved in a second direction (404), in particular substantially perpendicular to the first direction, and/or wherein, for reattaching the removable cap to the smoking substitute device, the removable cap is arranged to be moved in a second direction (404) and subsequently is arranged to be moved in a first direction (402), in particular substantially perpendicular to the second direction.

### TECHNICAL FIELD

The present invention relates to a smoking substitute device and particularly, although not exclusively, to a smoking substitute device that facilitates cleaning.

### BACKGROUND

The smoking of tobacco is generally considered to expose a smoker to potentially harmful substances. It is generally thought that a significant amount of the potentially harmful substances are generated through the heat caused by the burning and/or combustion of the tobacco and the constituents of the burnt tobacco in the tobacco smoke itself.

Conventional combustible smoking articles, such as cigarettes, typically comprise a cylindrical rod of tobacco comprising shreds of tobacco which is surrounded by a wrapper, and usually also a cylindrical filter axially aligned in an abutting relationship with the wrapped tobacco rod. The filter typically comprises a filtration material which is circumscribed by a plug wrap. The wrapped tobacco rod and the filter are joined together by a wrapped band of tipping paper that circumscribes the entire length of the filter and an adjacent portion of the wrapped tobacco rod. A conventional cigarette of this type is used by lighting the end opposite to the filter, and burning the tobacco rod. The smoker receives mainstream smoke into their mouth by drawing on the mouth end or filter end of the cigarette.

Combustion of organic material such as tobacco is known to produce tar and other potentially harmful by-products. There have been proposed various smoking substitute systems (or “substitute smoking systems”) in order to avoid the smoking of tobacco.

Such smoking substitute systems can form part of nicotine replacement therapies aimed at people who wish to stop smoking and overcome a dependence on nicotine.

Smoking substitute systems include electronic systems that permit a user to simulate the act of smoking by producing an aerosol (also referred to as a “vapour”) that is drawn into the lungs through the mouth (inhaled) and then exhaled. The inhaled aerosol typically bears nicotine and/or flavourings without, or with fewer of, the odour and health risks associated with traditional smoking.

In general, smoking substitute systems are intended to provide a substitute for the rituals of smoking, whilst providing the user with a similar experience and satisfaction to those experienced with traditional smoking and with combustible tobacco products. Some smoking substitute systems use smoking substitute articles (also referred to as a “consumables”) that are designed to resemble a traditional cigarette and are cylindrical in form with a mouthpiece at one end.

The popularity and use of smoking substitute systems has grown rapidly in the past few years. Although originally marketed as an aid to assist habitual smokers wishing to quit tobacco smoking, consumers are increasingly viewing smoking substitute systems as desirable lifestyle accessories.

There are a number of different categories of smoking substitute systems, each utilising a different smoking substitute approach.

One approach for a smoking substitute system is the so-called Heated Tobacco (“HT”) approach in which tobacco (rather than an “e-liquid”) is heated or warmed to release vapour. HT is also known as “heat not burn” (“HNB”). The tobacco may be leaf tobacco or reconstituted tobacco. The vapour may contain nicotine and/or flavourings. In the HT approach the intention is that the tobacco is heated but not burned, i.e. the tobacco does not undergo combustion.

A typical HT smoking substitute system may include a device and a consumable. The consumable may include the tobacco material. The device and consumable may be configured to be physically coupled together. In use, heat may be imparted to the tobacco material by a heating element of the device, wherein airflow through the tobacco material causes components in the tobacco material to be released as vapour. A vapour may also be formed from a carrier in the tobacco material (this carrier may for example include propylene glycol and/or vegetable glycerine) and additionally volatile compounds released from the tobacco. The released vapour may be entrained in the airflow drawn through the tobacco.

As the vapour passes through the consumable (entrained in the airflow) from the location of vaporisation to an outlet of the consumable (e.g. a mouthpiece), the vapour cools and condenses to form an aerosol for inhalation by the user. The aerosol will normally contain the volatile compounds.

In HT smoking substitute systems, heating as opposed to burning the tobacco material is believed to cause fewer, or smaller quantities, of the more harmful compounds ordinarily produced during smoking.

Consequently, the HT approach may reduce the odour and/or health risks that can arise through the burning, combustion and pyrolytic degradation of tobacco.

There may be a need for improved design of smoking substitute systems, in particular HT smoking substitute systems, to enhance the user experience and improve the function of the HT smoking substitute system.

The present disclosure has been devised in the light of the above considerations.

### SUMMARY OF THE INVENTION

At its most general, the present invention relates to a smoking substitute device that is easy to clean by a user.

According to a first aspect of the present invention, there is provided smoking substitute device comprising a body having a longitudinal extension, a cavity, arranged at an end of the body, for receiving an aerosol-generating consumable, a heating element arranged in the cavity and having a longitudinal extension substantially parallel to the longitudinal extension of the body and a removable cap covering the end of the body at which the cavity is arranged, wherein the removable cap comprises a first opening substantially parallel to the longitudinal extension of the heating element and wherein, when the removable cap is detached from the smoking substitute device, or the removable cap is reattached to the smoking substitute device, the heating element at least partially transitions through the first opening.

According to a second aspect of the present invention, there is provided a smoking substitute device, comprising a body having a longitudinal extension, a cavity arranged at an end of the body for receiving an aerosol-generating consumable, a heating element arranged in the cavity and having a longitudinal extension substantially parallel to the longitudinal extension of the body, and a removable cap covering the end of the body where the cavity is arranged at, wherein, for detaching the removable cap from the smoking substitute device, the removable cap is arranged to be moved in a first direction and subsequently moved in a second direction, in particular substantially perpendicular to the first direction, and/or wherein, for reattaching the removable cap to the smoking substitute device, the removable cap is arranged to be moved in a second direction and subsequently is arranged to be moved in a first direction, in particular substantially perpendicular to the second direction.

By providing a smoking substitute device according to the present invention, a cleaning of the smoking substitute device by a user of the device may be facilitated.

Such a smoking substitute device may comprise a removable cap comprising a first opening that is adapted in its shape and position to correspond to a heating element of the smoking substitute device. For example, when the removable cap is removed by a user, the heating element may transition or move through the opening. Depending on the relative size of the heating element and the opening, it may be conceivable that dirt, deposits and/or debris is removed from the heating element. In other words, the shape of the opening may be such that a very close transition or passing by of the opening and the heating element is obtained so that the opening may act as an element removing dirt, deposits and/or debris by scraping off the unwanted material of the surface of the heating element. Likewise in case a close contact or tight spacing is realised between the opening and the heating element, unwanted material arranged in the cavity of the smoking substitute device may remain in the removable cap while it being removed from the smoking substitute device, thereby removing dirt, deposits and/or debris from the smoking substitute device. Such a movement may in particular be substantially perpendicular to the longitudinal extension of the smoking substitute device and the heating element.

A detachment may in particular be a removal of the removable cap. The opening may be arranged in a part of the removable cap substantially parallel to the longitudinal extension of the heating element. Thus the longitudinal extension of the opening may be considered to be parallel to the longitudinal extension of the heating element. In addition, the heating elements, in particular when embodied as a rotational symmetrical heating elements like e.g. a rod heater, may further comprise a radial cross-section where the radial direction is perpendicular to the longitudinal extension of the heating element. By the same token, the removable cap may have a further or second opening that coincides with the radial cross-section, at least partially, of the heating element in that a removable of the removable cap not only removes dirt, deposits and debris from the heating element and/or the cavity when moving the heating element through the opening that is parallel to the longitudinal extension of the first opening, but may also remove unwanted material by moving the removable cap in longitudinal direction so that the second opening may move adjacent to the heating element and may scrape off dirt, deposits and/or debris. Such a movement may in particular be substantially perpendicular to the radial cross section of the heating element.

As such, in the context of the present invention two independent moving directions may be employed: a first direction that is substantially parallel to the longitudinal extension/perpendicular to the radial cross section of the heating element; and a second direction that is substantially perpendicular to the longitudinal extension/parallel to the radial cross section of the heating element. The first direction and the second direction may thus be substantially perpendicular to one another.

Optional features will now be set out. These are applicable singly or in any combination with any aspect.

According to a preferred embodiment of the present invention, the removable cap may comprise a second opening and the second opening may at least partially correspond to the shape of the radial cross section of the heating element and wherein, when the removable cap is detached from the smoking substitute device, or the removable cap is reattached to the smoking substitute device, the heating element at least partially transitions through the second opening.

According to a further preferred embodiment of the present invention, for detaching the removable cap from the smoking substitute device, the removable cap may be arranged to be moved in a first direction and subsequently moved in a second direction substantially perpendicular to the first direction, and/or wherein, for reattaching the removable cap to the smoking substitute device, the removable cap may be arranged to be moved in a second direction and subsequently may be arranged to be moved in a first direction substantially perpendicular to the first direction.

According to a further preferred embodiment of the present invention, the first direction may be a direction substantially parallel to the longitudinal axis of the smoking substitute device; and/or the second direction may be a direction substantially parallel to the radial axis of the smoking substitute device; and in particular the first direction and the second direction may be substantially perpendicular to one another.

With a second opening, a more thorough cleaning of the smoking substitute device may be performed. In particular, it may be conceivable that a first cleaning motion is performed where the heating element is cleaned by a movement through a first or second opening, a movement adjacent to the heating element, which may be followed by a second cleaning motion where the heating element is cleaned by a movement through the other first or second opening, a movement adjacent to the heating element. By providing two independent cleaning movements, the heating element may first be cleaned in a first direction, followed by cleaning in a second direction. For example dirt, deposits and debris resistant to a first movement direction may subsequently be cleaned by a movement in the second direction.

According to a further preferred embodiment of the present invention, at least one of the first opening and the second opening, when the removable cap is detached from the smoking substitute device, or the removable cap is reattached to the smoking substitute device, may be at least partially moving adjacent the heating element, so that debris, dirt and/or deposits are removed from the heating element.

A movement adjacent to the heating elements may be understood as a movement such that an outer surface area of the opening moves in the vicinity of the heating element, sufficiently close to make in contact with dirt, deposits and/or debris on the surface of the heating element and thereby removing, e.g. scraping off the unwanted material.

According to a further preferred embodiment of the present invention, the body may comprise an outer wall for substantially closing the first opening in the attached state.

By providing an outer wall in the vicinity of the first opening, the first opening may be closed so that a user of the device, in the process of consuming a smoking substitute consumable when inhaling, is not provided with a bypass stream of air from the outside through the first opening into the consumable, thereby possibly diluting the smoking experience. The outer wall may conform in its shape to the shape of the removable cap so that a sealing is effected by surface contact between the outer wall and the removable cap, in particular the inner surface of the outer wall and the outer surface of the removable cap. The material of either the outer wall, the removable cap or both may be such to promote a sealing of the first opening by the outer wall. Likewise, an additional layer of suitable sealing material may be provided either on the inner surface of the outer wall or the outer surface of the removable cap or both.

It is further conceivable that the first opening is not sealed off by an outer of wall, but a consumable inserted into the cavity comprises itself a suitable barrier layer, e.g. at its circumference, to avoid any air intake through the opening into the consumable thereby avoiding diluting the smoking experience.

According to a further preferred embodiment of the present invention, the first opening may be adapted for cleaning the heating element and/or removing debris, dirt and/or deposits from the cavity when removed from the smoking substitute device, in particular wherein cleaning the heating element may comprise removing debris, dirt or deposits from the heating element surface.

According to a further preferred embodiment of the present invention, the smoking substitute device may further comprise a locking element for locking the removable cap to the body during operation, wherein the locking element in particular may be arranged to be unlockable by a user of the smoking substitute device for removal of the removable cap, and further in particular the locking element may be arranged so that the second opening is engageable with the heating element, and/or is arranged as an elevation in the housing, in particular the outer wall, wherein the elevation is engageable with the first opening.

Such a locking element may be a relatively simple locking element, for example an elevation on the inner surface of the outer wall which is adapted to at least a part of the first opening and engageable with the first opening when in the inserted position so to establish a form fit. A similar locking element, alternatively or additionally, may be provided with the second opening. E.g. the heating element may comprise a slightly reduced diameter at a certain position along the longitudinal extension, which engages with the second opening having a corresponding profile to establish a form fit. Such may result in a movement of the second opening along the surface of the heating element, thereby removing dirt, deposits and/or debris until the second opening arrives at the reduced diameter area and snaps into place. A cleaning of the heating elements may in this case in particular be performed while removing the removable cap. Further alternatively, the locking elements may be provided on the housing or body of the smoking substitute device and may engage with a suitable matching counterpart in the removable cap. E.g., the body may comprise an elevation, while the removable cap comprises an indentation adapted to engage with the elevation for locking the removable cap in place when inserted.

According to a further preferred embodiment of the present invention, the smoking substitute device may further comprise a guide system for guiding a close-by movement of at least one of the first opening and the second opening relative to the heating element for scraping off debris, dirt and/or deposits from the heating element.

E.g., the body of the smoking substitute device may comprise guiding elements like gaps, recesses or the like for guiding matching counter elements on the removable cap to reduce the freedom of movement of the removable cap relative to the smoking substitute device, in particular to allow movement in only pre-determined select and defined directions. For example, a guide system may guide the removable cap in a first direction parallel to the longitudinal extension of both the smoking substitute device and the heating element and subsequently guide the removable cap in a second direction. Such may be achieved by linear indentations and matching elevations in one of the body and the removable cap. Separate guide systems for each defined direction is likewise conceivable. The movement of the heating element through the second opening may be a further example of such a guide system, while the movement of the heating element through the first opening may likewise define a defined, e.g. first, direction.

The device may comprise an elongate body. An end of the elongate body may be configured for engagement with an aerosol-forming article. For example, the body may be configured for engagement with a heated tobacco (HT) consumable (or heat-not-burn (HNB) consumable). The terms “heated tobacco” and “heat-not-burn” are used interchangeably herein to describe a consumable that is of the type that is heated rather than combusted (or are used interchangeably to describe a device for use with such a consumable). The device may comprise a cavity that is configured for receipt of at least a portion of the consumable (i.e. for engagement with the consumable). The aerosol-forming article may be of the type that comprises an aerosol former (e.g. carried by an aerosol-forming substrate).

The device may comprise a heater for heating the aerosol-forming article. The heater may comprise a heating element, which may be in the form of a rod that extends from the body of the device. The heating element may extend from the end of the body that is configured for engagement with the aerosol-forming article.

The heater (and thus the heating element) may be rigidly mounted to the body. The heating element may be elongate so as to define a longitudinal axis and may, for example, have a transverse profile (i.e. transverse to a longitudinal axis of the heating element) that is substantially circular (i.e. the heating element may be generally cylindrical). Alternatively, the heating element may have a transverse profile that is rectangular (i.e. the heater may be a “blade heater”). The heating element may alternatively be in the shape of a tube (i.e. the heater may be a “tube heater”). The heating element may take other forms (e.g. the heating element may have an elliptical transverse profile). The shape and/or size (e.g. diameter) of the transverse profile of the heating element may be generally consistent for the entire length (or substantially the entire length) of the heating element.

The heating element may be between 15 mm and 25 mm long, e.g. between 18 mm and 20 mm long, e.g. around 19 mm long. The heating element may have a diameter of between 1.5 mm and 2.5 mm, e.g. a diameter between 2 mm and 2.3 mm, e.g. a diameter of around 2.15 mm.

The heating element may be formed of ceramic. The heating element may comprise a core (e.g. a ceramic core) comprising Al2O3. The core of the heating element may have a diameter of 1.8 mm to 2.1 mm, e.g. between 1.9 mm and 2 mm. The heating element may comprise an outer layer (e.g. an outer ceramic layer) comprising Al2O3. The thickness of the outer layer may be between 160 μm and 220 μm, e.g. between 170 μm and 190 μm, e.g. around 180 μm. The heating element may comprise a heating track, which may extend longitudinally along the heating element. The heating track may be sandwiched between the outer layer and the core of the heating element. The heating track may comprise tungsten and/or rhenium. The heating track may have a thickness of around 20 μm.

The heating element may be located in the cavity (of the device), and may extend (e.g. along a longitudinal axis) from an internal base of the cavity towards a first opening of the cavity. The length of the heating element (i.e. along the longitudinal axis of the heater) may be less than the depth of the cavity. Hence, the heating element may extend for only a portion of the length of the cavity. That is, the heating element may not extend through (or beyond) the opening of the cavity.

The heating element may be configured for insertion into an aerosol-forming article (e.g. a HT consumable) when an aerosol-forming article is received in the cavity. In that respect, a distal end (i.e. distal from a base of the heating element where it is mounted to the device) of the heating element may comprise a tapered portion, which may facilitate insertion of the heating element into the aerosol-forming article. The heating element may fully penetrate an aerosol-forming article when the aerosol-forming article is received in the cavity. That is, the entire length, or substantially the entire length, of the heating element may be received in the aerosol-forming article.

The heating element may have a length that is less than, or substantially the same as, an axial length of an aerosol-forming substrate forming part of an aerosol-forming article (e.g. a HT consumable). Thus, when such an aerosol-forming article is engaged with the device, the heating element may only penetrate the aerosol-forming substrate, rather than other components of the aerosol-forming article. The heating element may penetrate the aerosol-forming substrate for substantially the entire axial length of the aerosol forming-substrate of the aerosol-forming article. Thus, heat may be transferred from (e.g. an outer circumferential surface of) the heating element to the surrounding aerosol-forming substrate, when penetrated by the heating element. That is, heat may be transferred radially outwardly (in the case of a cylindrical heating element) or e.g. radially inwardly (in the case of a tube heater).

Where the heater is a tube heater, the heating element of the tube heater may surround at least a portion of the cavity. When the portion of the aerosol-forming article is received in the cavity, the heating element may surround a portion of the aerosol-forming article (i.e. so as to heat that portion of the aerosol-forming article). In particular, the heating element may surround an aerosol forming substrate of the aerosol-forming article. That is, when an aerosol-forming article is engaged with the device, the aerosol forming substrate of the aerosol-forming article may be located adjacent an inner surface of the (tubular) heating element. When the heating element is activated, heat may be transferred radially inwardly from the inner surface of the heating element to heat the aerosol forming substrate.

The cavity may comprise a (e.g. circumferential) wall (or walls) and the (tubular) heating element may extend around at least a portion of the wall(s). In this way, the wall may be located between the inner surface of the heating element and an outer surface of the aerosol-forming article. The wall (or walls) of the cavity may be formed from a thermally conductive material (e.g. a metal) to allow heat conduction from the heating element to the aerosol-forming article. Thus, heat may be conducted from the heating element, through the cavity wall (or walls), to the aerosol-forming substrate of an aerosol-forming article received in the cavity.

In some embodiments the device may comprise an in particular removable cap disposed at the end of the body that is configured for engagement with an aerosol-forming article. Where the device comprises a heater having a heating element, the removable cap may at least partially enclose the heating element. The removable cap may be moveable between an open position in which access is provided to the heating element, and a closed position in which the removable cap at least partially encloses the heating element. The removable cap may be slideably engaged with the body of the device, and may be slideable between the open and closed positions. The removable cap may likewise be completely removable, in particular by a user operating the smoking substitute device.

The removable cap may define at least a portion of the cavity of the device. That is, the cavity may be fully defined by the removable cap, or each of the removable cap and body may define a portion of the cavity. Where the removable cap fully defines the cavity, the removable cap may comprise an aperture for receipt of the heating element into the cavity (when the removable cap is in the closed position). The removable cap may comprise a first opening to the cavity. The opening may be configured for receipt of at least a portion of an aerosol-forming article. That is, an aerosol-forming article may be inserted through the opening and into the cavity (so as to be engaged with the device).

The removable cap may be configured such that when an aerosol-forming article is engaged with the device (e.g. received in the cavity), only a portion of the aerosol-forming article is received in the cavity. That is, a portion of the aerosol-forming article (not received in the cavity) may protrude from (i.e. extend beyond) the opening. This (protruding) portion of the aerosol-forming article may be a terminal (e.g. mouth) end of the aerosol-forming article, which may be received in a user's mouth for the purpose of inhaling aerosol formed by the device.

The device may comprise a power source or may be connectable to a power source (e.g. a power source separate to the device). The power source may be electrically connectable to the heater. In that respect, altering (e.g. toggling) the electrical connection of the power source to the heater may affect a state of the heater. For example, toggling the electrical connection of the power source to the heater may toggle the heater between an on state and an off state. The power source may be a power store. For example, the power source may be a battery or rechargeable battery (e.g. a lithium ion battery).

The device may comprise an input connection (e.g. a USB port, Micro USB port, USB-C port, etc.). The input connection may be configured for connection to an external source of electrical power, such as a mains electrical supply outlet. The input connection may, in some cases, be used as a substitute for an internal power source (e.g. battery or rechargeable battery). That is, the input connection may be electrically connectable to the heater (for providing power to the heater). Hence, in some forms, the input connection may form at least part of the power source of the device.

Where the power source comprises a rechargeable power source (such as a rechargeable battery), the input connection may be used to charge and recharge the power source.

The device may comprise a user interface (UI). In some embodiments the UI may include input means to receive operative commands from the user. The input means of the UI may allow the user to control at least one aspect of the operation of the device. In some embodiments the input means may comprise a power button to switch the device between an on state and an off state.

In some embodiments the UI may additionally or alternatively comprise output means to convey information to the user. In some embodiments the output means may comprise a light to indicate a condition of the device (and/or the aerosol-forming article) to the user. The condition of the device (and/or aerosol-forming article) indicated to the user may comprise a condition indicative of the operation of the heater. For example, the condition may comprise whether the heater is in an off state or an on state. In some embodiments, the UI unit may comprise at least one of a button, a display, a touchscreen, a switch, a light, and the like. For example, the output means may comprise one or more (e.g. two, three, four, etc.) light-emitting diodes (“LEDs”) that may be located on the body of the device.

The device may further comprise a puff sensor (e.g. airflow sensor), which form part of the input means of the UI. The puff sensor may be configured to detect a user drawing on an end (i.e. a terminal (mouth) end) of the aerosol-forming article. The puff sensor may, for example, be a pressure sensor or a microphone. The puff sensor may be configured to produce a signal indicative of a puff state. The signal may be indicative of the user drawing (an aerosol from the aerosol-forming article) such that it is e.g. in the form of a binary signal. Alternatively or additionally, the signal may be indicative of a characteristic of the draw (e.g. a flow rate of the draw, length of time of the draw, etc).

The device may comprise a controller, or may be connectable to a controller that may be configured to control at least one function of the device. The controller may comprise a microcontroller that may e.g. be mounted on a printed circuit board (PCB). The controller may also comprise a memory, e.g. non-volatile memory. The memory may include instructions, which, when implemented, may cause the controller to perform certain tasks or steps of a method. Where the device comprises an input connection, the controller may be connected to the input connection.

The controller may be configured to control the operation of the heater (and e.g. the heating element). Thus, the controller may be configured to control vaporisation of an aerosol forming part of an aerosol-forming article engaged with the device. The controller may be configured to control the voltage applied by power source to the heater. For example, the controller may be configured to toggle between applying a full output voltage (of the power source) to the heater and applying no voltage to the heater. Alternatively or additionally, the control unit may implement a more complex heater control protocol.

The device may further comprise a voltage regulator to regulate the output voltage supplied by the power source to form a regulated voltage. The regulated voltage may subsequently be applied to the heater.

In some embodiments, where the device comprises a UI, the controller may be operatively connected to one or more components of the UI. The controller may be configured to receive command signals from an input means of the UI. The controller may be configured to control the heater in response to the command signals. For example, the controller may be configured to receive “on” and “off” command signals from the UI and, in response, may control the heater so as to be in a corresponding on or off state.

The controller may be configured to send output signals to a component of the UI. The UI may be configured to convey information to a user, via an output means, in response to such output signals (received from the controller). For example, where the device comprises one or more LEDs, the LEDs may be operatively connected to the controller. Hence, the controller may configured to control the illumination of the LEDs (e.g. in response to an output signal). For example, the controller may be configured to control the illumination of the LEDs according to (e.g. an on or off) state of the heater.

Where the device comprises a sensor (e.g. a puff/airflow sensor), the controller may be operatively connected to the sensor. The controller may be configured to receive a signal from the sensor (e.g. indicative of a condition of the device and/or engaged aerosol-forming article). The controller may be configured to control the heater, or an aspect of the output means, based on the signal from the sensor.

The device may comprise a wireless interface configured to communicate wirelessly (e.g. via Bluetooth (e.g. a Bluetooth low-energy connection) or WiFi) with an external device. Similarly, the input connection may be configured for wired connection to an external device so as to provide communication between the device and the external device.

The external device may be a mobile device. For example, the external device may be a smart phone, tablet, smart watch, or smart car. An application (e.g. app) may be installed on the external device (e.g. mobile device). The application may facilitate communication between the device and the external device via the wired or wireless connection.

The wireless or wired interface may be configured to transfer signals between the external device and the controller of the device. In this respect, the controller may control an aspect of the device in response to a signal received from an external device. Alternatively or additionally, an external device may respond to a signal received from the device (e.g. from the controller of the device).

Further according to the invention, there may be provided a system (e.g. a smoking substitute system) comprising a device according to one of the previous aspects and an aerosol-forming article. The aerosol-forming article may comprise an aerosol-forming substrate at an upstream end of the aerosol-forming article. The article may be in the form of a smoking substitute article, e.g. heated tobacco (HT) consumable (also known as a heat-not-burn (HNB) consumable).

As used herein, the terms “upstream” and “downstream” are intended to refer to the flow direction of the vapour/aerosol i.e. with the downstream end of the article/consumable being the mouth end or outlet where the aerosol exits the consumable for inhalation by the user. The upstream end of the article/consumable is the opposing end to the downstream end.

The aerosol-forming substrate is capable of being heated to release at least one volatile compound that can form an aerosol. The aerosol-forming substrate may be located at the upstream end of the article/consumable.

In order to generate an aerosol, the aerosol-forming substrate comprises at least one volatile compound that is intended to be vaporised/aerosolised and that may provide the user with a recreational and/or medicinal effect when inhaled. Suitable chemical and/or physiologically active volatile compounds include the group consisting of: nicotine, cocaine, caffeine, opiates and opoids, cathine and cathinone, kavalactones, mysticin, beta-carboline alkaloids, salvinorin A together with any combinations, functional equivalents to, and/or synthetic alternatives of the foregoing.

The aerosol-forming substrate may comprise plant material. The plant material may comprise least one plant material selected from the list including Amaranthus dubius, Arctostaphylos uva-ursi (Bearberry), Argemone mexicana, amica, Artemisia vulgaris, Yellow Tees, Galea zacatechichi, Canavalia maritima (Baybean), Cecropia mexicana (Guamura), Cestrum noctumum, Cynoglossum virginianum (wild comfrey), Cytisus scoparius, Damiana, Entada rheedii, Eschscholzia californica (California Poppy), Fittonia albivenis, Hippobroma longiflora, Humulus japonica (Japanese Hops), Humulus lupulus (Hops), Lactuca virosa (Lettuce Opium), Laggera alata, Leonotis leonurus, Leonurus cardiaca (Motherwort), Leonurus sibiricus (Honeyweed), Lobelia cardinalis, Lobelia inflata (Indian-tobacco), Lobelia siphilitica, Nepeta cataria (Catnip). Nicotiana species (Tobacco), Nymphaea alba (White Lily), Nymphaea caerulea (Blue Lily), Opium poppy, Passiflora incamata (Passionflower), Pedicularis densiflora (Indian Warrior), Pedicularis groenlandica (Elephant's Head), Salvia divinorum, Salvia dorrii (Tobacco Sage), Salvia species (Sage), Scutellaria galericulata, Scutellaria lateriflora, Scutellaria nana, Scutellaria species (Skullcap), Sida acuta (Wireweed), Sida rhombifolia, Silene capensis, Syzygium aromaticum (Clove), Tagetes lucida (Mexican Tarragon), Tarchonanthus camphoratus, Tumera diffusa (Damiana), Verbascum (Mullein), Zamia latifolia (Maconha Brava) together with any combinations, functional equivalents to, and/or synthetic alternatives of the foregoing.

The plant material may be tobacco. Any type of tobacco may be used. This includes, but is not limited to, flue-cured tobacco, burley tobacco, Maryland Tobacco, dark-air cured tobacco, oriental tobacco, dark-fired tobacco, perique tobacco and rustica tobacco. This also includes blends of the above-mentioned tobaccos.

The tobacco may comprise one or more of leaf tobacco, stem tobacco, tobacco powder, tobacco dust, tobacco derivatives, expanded tobacco, homogenised tobacco, shredded tobacco, extruded tobacco, cut rag tobacco and/or reconstituted tobacco (e.g. slurry recon or paper recon).

The aerosol-forming substrate may comprise a gathered sheet of homogenised (e.g. paper/slurry recon) tobacco or gathered shreds/strips formed from such a sheet.

The aerosol-forming substrate may comprise one or more additives selected from humectants, flavourants, fillers, aqueous/non-aqueous solvents and binders.

The flavourant may be provided in solid or liquid form. It may include menthol, liquorice, chocolate, fruit flavour (including e.g. citrus, cherry etc.), vanilla, spice (e.g. ginger, cinnamon) and tobacco flavour. The flavourant may be evenly dispersed throughout the aerosol-forming substrate or may be provided in isolated locations and/or varying concentrations throughout the aerosol-forming substrate.

The aerosol-forming substrate may be formed in a substantially cylindrical shape such that the article/consumable resembles a conventional cigarette. It may have a diameter of between 5 and 10 mm e.g. between 6 and 9 mm or 6 and 8 mm e.g. around 7 mm. It may have an axial length of between 10 and 15 mm e.g. between 11 and 14 mm such as around 12 or 13 mm.

The article/consumable may comprise at least one filter element. There may be a terminal filter element at the downstream/mouth end of the article/consumable.

The or at least one of the filter element(s) (e.g. the terminal filter element) may be comprised of cellulose acetate or polypropylene tow. The at least one filter element (e.g. the terminal filter element) may be comprised of activated charcoal. The at least one filter element (e.g. the terminal element) may be comprised of paper. The or each filter element may be at least partly (e.g. entirely) circumscribed with a plug wrap e.g. a paper plug wrap.

The terminal filter element (at the downstream end of the article/consumable) may be joined to the upstream elements forming the article/consumable by a circumscribing tipping layer e.g. a tipping paper layer. The tipping paper may have an axial length longer than the axial length of the terminal filter element such that the tipping paper completely circumscribes the terminal filter element plus the wrapping layer surrounding any adjacent upstream element.

In some embodiments, the article/consumable may comprise an aerosol-cooling element which is adapted to cool the aerosol generated from the aerosol-forming substrate (by heat exchange) before being inhaled by the user.

The article/consumable may comprise a spacer element that defines a space or cavity between the aerosol-forming substrate and the downstream end of the consumable. The spacer element may comprise a cardboard tube. The spacer element may be circumscribed by the (paper) wrapping layer.

According to a third aspect of the present invention, there is provided a method for cleaning of an smoking substitute device according to one of the first and second aspects, the smoking substitute device comprising a body having a longitudinal extension, a cavity, arranged at an end of the body, for receiving an aerosol-generating consumable, a heating element arranged in the cavity and having a longitudinal extension substantially parallel to the longitudinal extension of the body and a removable cap covering the end of the body at which the cavity is arranged at, the method comprising moving the removable cap in a first direction and moving subsequently the removable cap in a second direction, wherein the second direction is in particular substantially perpendicular to the first direction, wherein, by the movement in at least one of the first direction and/or the second direction, the heating element is cleaned.

According to a further preferred embodiment of the present invention, cleaning the heating element may comprise removing debris, dirt or deposits from the heating element surface.

According to a further preferred embodiment of the present invention, the removable cap further may comprise a first opening substantially parallel to the longitudinal extension of the heating element, wherein, when the removable cap is detached from the smoking substitute device, or the removable cap is reattached to the smoking substitute device, the heating element may at least partially transition through the first opening.

According to a further preferred embodiment of the present invention, the first opening, when the removable cap is detached from the smoking substitute device or the removable cap is reattached to the smoking substitute device, may at least partially move adjacent the heating element, so that debris, dirt and/or deposits are removed from the heating element.

According to a further preferred embodiment of the present invention, the removable cap further may comprise a second opening at least partially corresponding to the shape of the radial cross section of the heating element, wherein the second opening, when the removable cap may be detached from the smoking substitute device or the removable cap is reattached to the smoking substitute device, is at least partially moving adjacent the heating element, so that debris, dirt and/or deposits are removed from the heating element.

The invention includes the combination of the aspects and preferred features described except where such a combination is clearly impermissible or expressly avoided.

The skilled person will appreciate that except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

### SUMMARY OF THE FIGURES

So that the invention may be understood, and so that further aspects and features thereof may be appreciated, embodiments illustrating the principles of the invention will now be discussed in further detail with reference to the accompanying figures, in which:

FIG. 1A is a schematic of a smoking substitute system;

FIG. 1B is a schematic of a variation of the smoking substitute system of FIG. 1A;

FIG. 2A is a front view of a first embodiment of a smoking substitute system with the consumable engaged with the device;

FIG. 2B is a front view of the first embodiment of the smoking substitute system with the consumable disengaged from the device;

FIG. 2C is a section view of the consumable of the first embodiment of the smoking substitute system;

FIG. 2D is a detailed view of an end of the device of the first embodiment of the smoking substitute system;

FIG. 2E is a section view of the first embodiment of the substitute smoking system;

FIGS. 3A and 3B are detailed views of a removable cap according to the present invention; and

FIGS. 4A to 4E are detailed views of an exemplary removing of the removable cap according to the present invention.

### DETAILED DESCRIPTION OF THE INVENTION

Aspects and embodiments of the present invention will now be discussed with reference to the accompanying figures. Further aspects and embodiments will be apparent to those skilled in the art. All documents mentioned in this text are incorporated herein by reference.

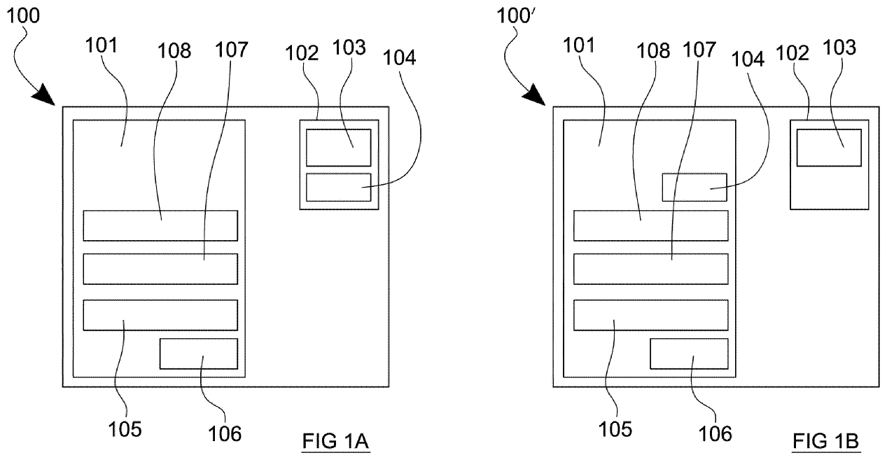

FIG. 1A is a schematic providing a general overview of a smoking substitute system 100. The system 100 includes a substitute smoking device 101 and an aerosol-forming article in the form of a consumable 102, which comprises an aerosol former 103. The system is configured to vaporise the aerosol former by heating the aerosol former 103 (so as to form a vapour/aerosol for inhalation by a user).

In the illustrated system, the heater 104 forms part of the consumable 102 and is configured to heat the aerosol former 103. In this variation, the heater 104 is electrically connectable to the power source 105, for example, when the consumable 102 is engaged with the device 101. Heat from the heater 104 vaporises the aerosol former 103 to produce a vapour. The vapour subsequently condenses to form an aerosol, which is ultimately inhaled by the user.

The system 100 further comprises a power source 105 that forms part of the device 101. In other embodiments the power source 105 may be external to (but connectable to) the device 101. The power source 105 is electrically connectable to the heater 104 such that it is able to supply power to the heater 104 (i.e. for the purpose of heating the aerosol former 103). Thus, control of the electrical connection of the power source 105 to the heater 104 provides control of the state of the heater 104. The power source 105 may be a power store, for example a battery or rechargeable battery (e.g. a lithium ion battery).

The system 100 further comprises an I/O module comprising a connector 106 (e.g. in the form of a USB port, Micro USB port, USB-C port, etc.). The connector 106 is configured for connection to an external source of electrical power, e.g. a mains electrical supply outlet. The connector 106 may be used in substitution for the power source 105. That is the connector 106 may be electrically connectable to the heater 104 so as to supply electricity to the heater 104. In such embodiments, the device may not include a power source, and the power source of the system may instead comprise the connector 106 and an external source of electrical power (to which the connector 106 provides electrical connection).

In some embodiments, the connector 106 may be used to charge and recharge the power source 105 where the power source 105 includes a rechargeable battery.

The system 100 also comprises a user interface (UI) 107. Although not shown, the UI 107 may include input means to receive commands from a user. The input means of the UI 107 allows the user to control at least one aspect of the operation of the system 100. The input means may, for example, be in the form of a button, touchscreen, switch, microphone, etc.

The UI 107 also comprises output means to convey information to the user. The output means may, for example, comprise lights (e.g. LEDs), a display screen, speaker, vibration generator, etc.

The system 100 further comprises a controller 108 that is configured to control at least one function of the device 101. In the illustrated embodiment, the controller 108 is a component of the device 101, but in other embodiments may be separate from (but connectable to) the device 101. The controller 108 is configured to control the operation of the heater 104 and, for example, may be configured to control the voltage applied from the power source 105 to the heater 104. The controller 108 may be configured to toggle the supply of power to the heater 104 between an on state, in which the full output voltage of the power source 105 is applied to the heater 104, and an off state, in which the no voltage is applied to the heater 104.

Although not shown, the system 100 may also comprise a voltage regulator to regulate the output voltage from the power source 105 to form a regulated voltage. The regulated voltage may then be applied to the heater 104.

In addition to being connected to the heater 104, the controller 108 is operatively connected to the UI 107. Thus, the controller 108 may receive an input signal from the input means of the UI 107. Similarly, the controller 108 may transmit output signals to the UI 107. In response, the output means of the UI 107 may convey information, based on the output signals, to a user. The controller also comprises a memory 109, which is a non-volatile memory. The memory 109 includes instructions, which, when implemented, cause the controller to perform certain tasks or steps of a method.

FIG. 1B is a schematic showing a variation of the system 100 of FIG. 1A. In the system 100′ of FIG. 1B, the heater 104 forms part of the device 101, rather than the consumable 102. In this variation, the heater 104 is electrically connected to the power source 105.

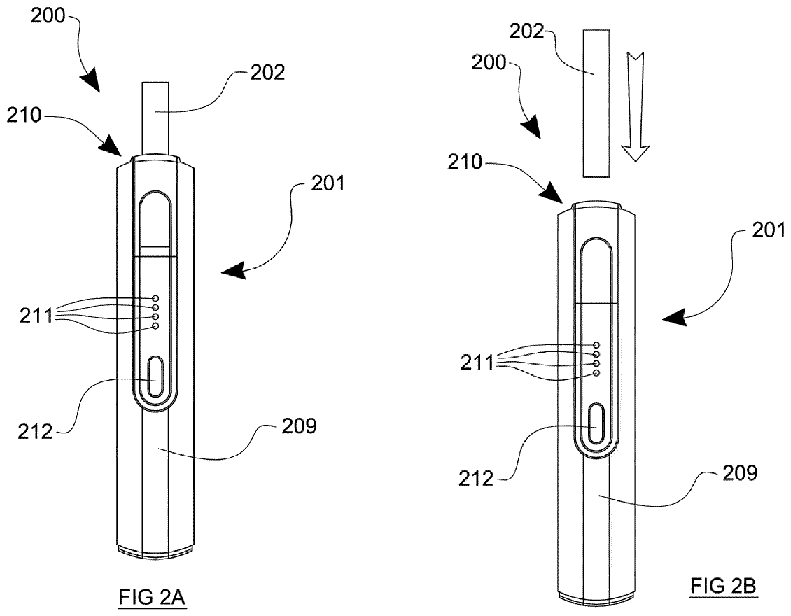

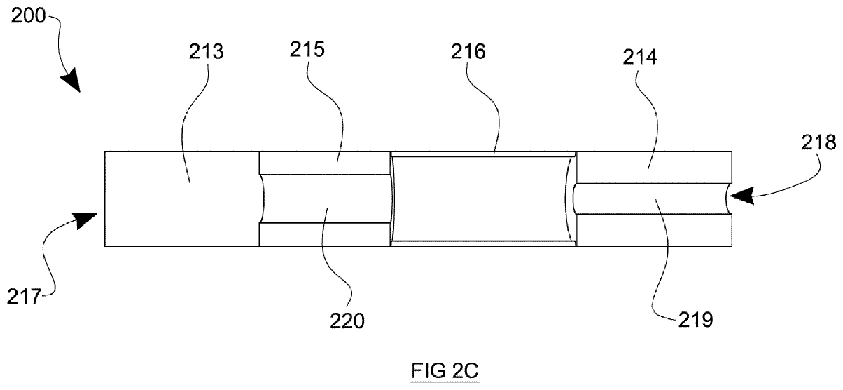

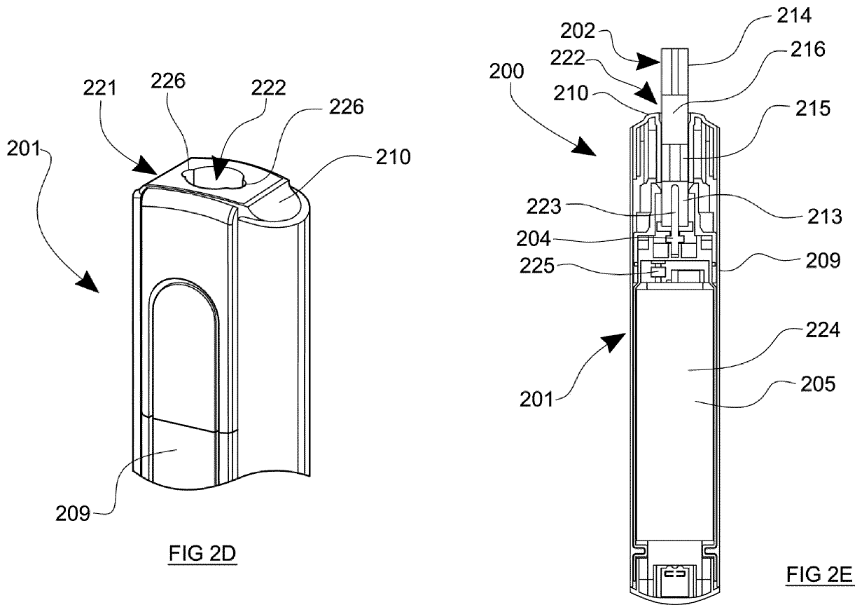

FIGS. 2A and 2B illustrate a heated-tobacco (HT) smoking substitute system 200. The system 200 is an example of the systems 100, 100′ described in relation to FIG. 1A or 1B. System 200 includes an HT device 201 and an HT consumable 202. The description of FIGS. 1A and 1B above is applicable to the system 200 of FIGS. 2A and 2B, and will thus not be repeated.

The device 201 and the consumable 202 are configured such that the consumable 202 can be engaged with the device 201. FIG. 2A shows the device 201 and the consumable 202 in an engaged state, whilst FIG. 2B shows the device 201 and the consumable 202 in a disengaged state.

The device 201 comprises a body 209 and removable cap 210. In use the removable cap 210 is engaged at an end of the body 209. Although not apparent from the figures, the removable cap 210 is moveable relative to the body 209. In particular, the removable cap 210 is slideable and can slide along a longitudinal axis of the body 209. Further in particular, the removable cap 210 is completely removable, in other words separable, from the body 209 and thus the smoking substitute device 201.

The device 201 comprises an output means (forming part of the UI of the device 201) in the form of a plurality of light-emitting diodes (LEDs) 211 arranged linearly along the longitudinal axis of the device 201 and on an outer surface of the body 209 of the device 201. A button 212 is also arranged on an outer surface of the body 209 of the device 201 and is axially spaced (i.e. along the longitudinal axis) from the plurality of LEDs 211.

FIG. 2C shows a detailed section view of the consumable of 202 of the system 200. The consumable 202 generally resembles a cigarette. In that respect, the consumable 202 has a generally cylindrical form with a diameter of 7 mm and an axial length of 70 mm. The consumable 202 comprises an aerosol forming substrate 213, a terminal filter element 214, an upstream filter element 215 and a spacer element 216. In other embodiments, the consumable may further comprise a cooling element. A cooling element may exchange heat with vapour that is formed by the aerosol-forming substrate 213 in order to cool the vapour so as to facilitate condensation of the vapour.

The aerosol-forming substrate 213 is substantially cylindrical and is located at an upstream end 217 of the consumable 202, and comprises the aerosol former of the system 200. In that respect, the aerosol forming substrate 213 is configured to be heated by the device 201 to release a vapour. The released vapour is subsequently entrained in an airflow flowing through the aerosol-forming substrate 213. The airflow is produced by the action of the user drawing on a downstream 218 (i.e. terminal or mouth) end of the consumable 202.

In the present embodiment, the aerosol forming substrate 213 comprises tobacco material that may, for example, include any suitable parts of the tobacco plant (e.g. leaves, stems, roots, bark, seeds and flowers). The tobacco may comprise one or more of leaf tobacco, stem tobacco, tobacco powder, tobacco dust, tobacco derivatives, expanded tobacco, homogenised tobacco, shredded tobacco, extruded tobacco, cut rag tobacco and/or reconstituted tobacco (e.g. slurry recon or paper recon). For example, the aerosol-forming substrate 213 may comprise a gathered sheet of homogenised (e.g. paper/slurry recon) tobacco or gathered shreds/strips formed from such a sheet.

In order to generate an aerosol, the aerosol forming substrate 213 comprises at least one volatile compound that is intended to be vaporised/aerosolised and that may provide the user with a recreational and/or medicinal effect when inhaled. The aerosol-forming substrate 213 may further comprise one or more additives. For example, such additives may be in the form of humectants (e.g. propylene glycol and/or vegetable glycerine), flavourants, fillers, aqueous/non-aqueous solvents and/or binders.

The terminal filter element 214 is also substantially cylindrical, and is located downstream of the aerosol forming substrate 213 at the downstream end 218 of the consumable 202. The terminal filter element 214 is in the form of a hollow bore filter element having a bore 219 (e.g. for airflow) formed therethrough. The diameter of the bore 219 is 2 mm. The terminal filter element 214 is formed of a porous (e.g. monoacetate) filter material. As set forth above, the downstream end 218 of the consumable 202 (i.e. where the terminal filter 214 is located) forms a mouthpiece portion of the consumable 202 upon which the user draws. Airflow is drawn from the upstream end 217, thorough the components of the consumable 202, and out of the downstream end 218. The airflow is driven by the user drawing on the downstream end 218 (i.e. the mouthpiece portion) of the consumable 202.

The upstream filter element 215 is located axially adjacent to the aerosol-forming substrate 213, between the aerosol-forming substrate 213 and the terminal filter element 214. Like the terminal filter 214, the upstream filter element 215 is in the form of a hollow bore filter element, such that it has a bore 220 extending axially therethrough. In this way, the upstream filter 215 may act as an airflow restrictor. The upstream filter element 215 is formed of a porous (e.g. monoacetate) filter material. The bore 220 of the upstream filter element 215 has a larger diameter (3 mm) than the terminal filter element 214.

The spacer 216 is in the form of a cardboard tube, which defines a cavity or chamber between the upstream filter element 215 and the terminal filter element 214. The spacer 216 acts to allow both cooling and mixing of the vapour/aerosol from the aerosol-forming substrate 213. The spacer has an external diameter of 7 mm and an axial length of 14 mm.

Although not apparent from the Figure, the aerosol-forming substrate 213, upstream filter 215 and spacer 216 are circumscribed by a paper wrapping layer. The terminal filter 214 is circumscribed by a tipping layer that also circumscribes a portion of the paper wrapping layer (so as to connect the terminal filter 214 to the remaining components of the consumable 202). The upstream filter 215 and terminal filter 214 are circumscribed by further wrapping layers in the form of plug wraps.

Returning now to the device 201, FIG. 2D illustrates a detailed view of the end of the device 201 that is configured to engage with the consumable 202. The removable cap 210 of the device 201 includes a first opening 221 to an internal cavity 222 (more apparent from FIG. 2D) defined by the removable cap 210. The opening 221 and the cavity 222 are formed so as to receive at least a portion of the consumable 202. During engagement of the consumable 202 with the device 201, a portion of the consumable 202 is received through the opening 221 and into the cavity 222. After engagement (see FIG. 2B), the downstream end 218 of the consumable 202 protrudes from the opening 221 and thus also protrudes from the device 201. The opening 221 includes laterally disposed notches 226. When a consumable 202 is received in the opening 221, these notches 226 remain open and could, for example, be used for retaining a cover in order to cover the end of the device 201.

FIG. 2E shows a cross section through a central longitudinal plane through the device 201. The device 201 is shown with the consumable 202 engaged therewith.

The device 201 comprises a heater 204 comprising heating element 223. The heater 204 forms part of the body 209 of the device 201 and is rigidly mounted to the body 209. In the illustrated embodiment, the heater 204 is a rod heater with a heating element 223 having a circular transverse profile. In other embodiments the heater may be in the form of a blade heater (e.g. heating element with a rectangular transverse profile) or a tube heater (e.g. heating element with a tubular form).

The heating element 223 of the heater 204 projects from an internal base of the cavity 222 along a longitudinal axis towards the opening 221. As is apparent from the Figure, the length (i.e. along the longitudinal axis) of the heating element is less than a depth of the cavity 222. In this way, the heating element 223 does not protrude from or extend beyond the opening 221.

When the consumable 202 is received in the cavity 222 (as is shown in FIG. 2E), the heating element 223 penetrates the aerosol-forming substrate 213 of the consumable 202. In particular, the heating element 223 extends for nearly the entire axial length of the aerosol-forming substrate 213 when inserted therein. Thus, when the heater 204 is activated, heat is transferred radially from an outer circumferential surface the heating element 223 to the aerosol-forming substrate 213.

The device 201 further comprises an electronics cavity 224. A power source, in the form of a rechargeable battery 205 (a lithium ion battery), is located in electronics cavity 224.

The device 201 includes a connector (i.e. forming part of an IO module of the device 201) in the form of a USB port 206. The connector may alternatively be, for example, a micro-USB port or a USB-C port for examples. The USB port 206 may be used to recharge the rechargeable battery 205.

The device 201 includes a controller (not shown) located in the electronics cavity 224. The controller comprises a microcontroller mounted on a printed circuit board (PCB). The USB port 206 is also connected to the controller 208 (i.e. connected to the PCB and microcontroller).

The controller 208 is configured to control at least one function of the device 202. For example, the controller 208 is configured to control the operation of the heater 204. Such control of the operation of the heater 204 may be accomplished by the controller toggling the electrical connection of the rechargeable battery 205 to the heater 204. For example, the controller 208 is configured to control the heater 204 in response to a user depressing the button 212. Depressing the button 212 may cause the controller to allow a voltage (from the rechargeable battery 205) to be applied to the heater 204 (so as to cause the heating element 223 to be heated).

The controller is also configured to control the LEDs 211 in response to (e.g. a detected) a condition of the device 201 or the consumable 202. For example, the controller may control the LEDs to indicate whether the device 201 is in an on state or an off state (e.g. one or more of the LEDs may be illuminated by the controller when the device is in an on state).

The device 201 comprises a further input means (i.e. in addition to the button 212) in the form of a puff sensor 225. The puff sensor 225 is configured to detect a user drawing (i.e. inhaling) at the downstream end 218 of the consumable 202. The puff sensor 225 may, for example, be in the form of a pressure sensor, flowmeter or a microphone. The puff sensor 225 is operatively connected to the controller 208 in the electronics cavity 224, such that a signal from the puff sensor 225, indicative of a puff state (i.e. drawing or not drawing), forms an input to the controller 208 (and can thus be responded to by the controller 208).

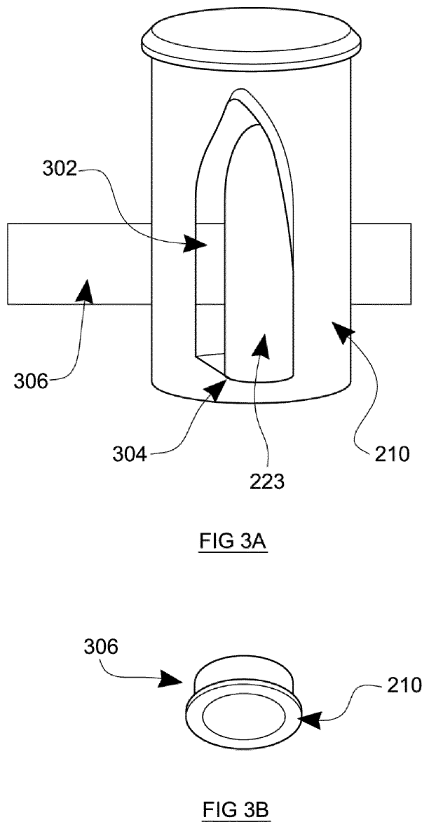

Now referring to FIGS. 3A and 3B, where detailed views of a removable cap according to the present invention are depicted.

FIG. 3A shows a perspective view of a removable cap 210 schematically. The front side of the removable cap 210 is omitted so to show the inside of the removable cap 210. In the interior of the removable cap 210, a heating element 223 is arranged, exemplarily depicted as a rod-shaped element. The backside of the removable cap 210 shows a first opening 302 which extends substantially in the longitudinal direction of the heating element 223. The first opening 302 is shaped so to correspond to the shape of the heating element 223. In other words, a projection of the heating element 223 towards the backside of the removable cap 210 defines the shape of the first opening 302. The dimensions of the first opening 302 are such that they correspond with the dimensions of the heating element 223 so that when the heating element 123 is moved through the opening 302, the surfaces move adjacent, in particular are in contact to an extent that on the one hand the heating element 223 is movable through the first opening 302 and on the other hand deposits and debris arranged on the surface of heating element 223 are removed by a scraping of the surface of the circumference of the first opening 302 across the surface of the heating element 123.

A partial view of the outer wall 306 can be seen in FIG. 3A. The outer wall 306 is arranged at the outside of the opening 302 and resting against the outer surface of the removable cap 210, thereby effectively closing the first opening 302.

FIG. 3B shows the alignment of the outer wall 306 relative to the removable cap 210 seen in the direction of the longitudinal extension of the smoking substitute device. As may be seen from FIG. 3B, the outer wall 306 rests against the surface of the removable cap 210, thereby effectively closing the first opening 302.

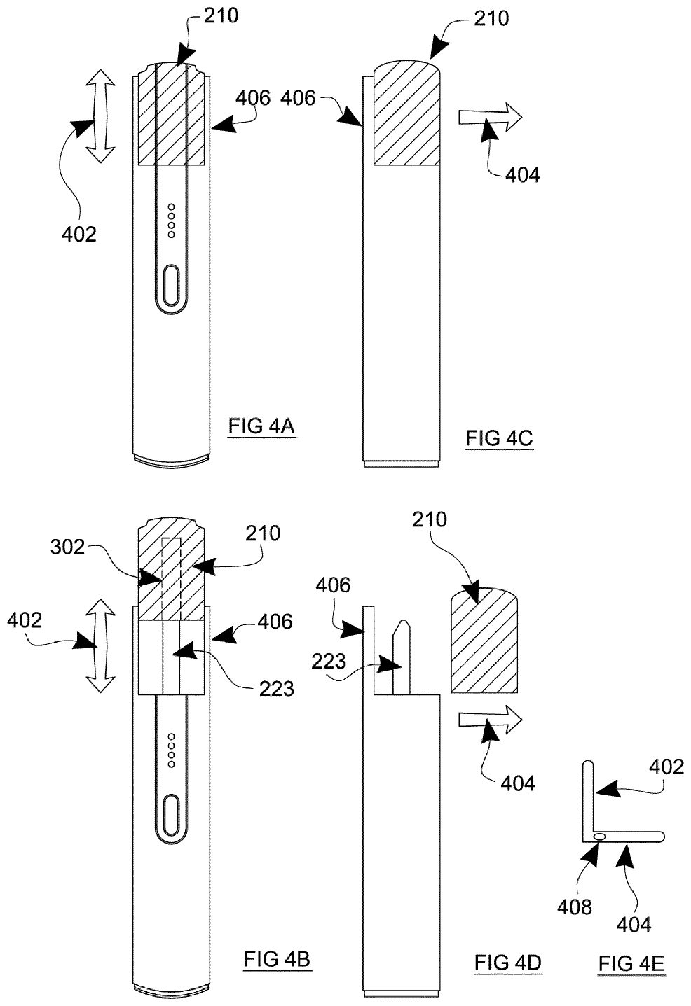

Now referring to FIGS. 4A to 4E, where detailed views of an exemplary removing of the removable cap according to the present invention are depicted.

FIGS. 4A and 4B show the smoking substitute device 201 from a direction comparable to FIGS. 2A and 2B, whereas FIGS. 4C and 4D show the smoking substitute device 201 turned 90° sideways. In FIGS. 4A and 4C, the removable cap 210 is situated attached to the body of smoking substitute device 201, whereas in FIGS. 4B and 4D, the removable cap 210 has been removed from the body of the smoking substitute device 201.

In order to remove the removable cap 210, a first movement in a first direction 402 has to be performed, namely moving the removable cap 210 in a direction parallel to the longitudinal extension of the body of the smoking substitute device 210. In FIG. 4B, the removable cap 210 has been raised from the body of the smoking substitute device 201 guided by the guide system 406 and has thus exposed heating element 223. A subsequent movement in a second direction 404 removes the removable cap 210 from the smoking substitute device as may be seen in FIG. 4D.

By a combination of movements 402 and 404, the removable cap 210 is effectively removed from the smoking substitute device 201. The first opening 302 is depicted schematically in FIG. 4B. During the removal (and a subsequent re-insertion or reattachment), heating element 223 has to transition or move through the first opening 302 and is cleaned in the process of this movement. Likewise any dirt, deposits and/or debris within the interior of the removable cap 210, namely the cavity 222, are likewise removed and remains in the interior of the removable cap. Due to the adapted shape of the heating element 2023 and the first opening 302, no unwanted material may pass between the circumference of the first opening 302 and the heating element 223. The same applies for the second opening 304, which is not depicted in FIGS. 4A to 4D.

FIG. 4E shows the general relationship between the movement in the first direction 402 and the movement in the second direction 404, which preferably may be substantially perpendicular to one another. E.g., movement in the first direction 402 may be substantially parallel to the longitudinal axis of the heating element 223 and the body of the smoking substitute device 201, respectively, while the movement in the second direction 404 is substantially parallel to the radial cross section of the heating element 223 or perpendicular to the longitudinal extension of the heating element 223 and the body of the smoking substitute device 210. FIG. 4E shows a locking element 408, exemplarily embodied as an indentation into which a suitable element arranged at the body of the smoking substitute device 201 may be engage with for locking the removable cap in place when installed in the smoking substitute device 201 for use.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the words “have”, “comprise”, and “include”, and variations such as “having”, “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means, for example, +/−10%.

The words “preferred” and “preferably” are used herein refer to embodiments of the invention that may provide certain benefits under some circumstances. It is to be appreciated, however, that other embodiments may also be preferred under the same or different circumstances. The recitation of one or more preferred embodiments therefore does not mean or imply that other embodiments are not useful, and is not intended to exclude other embodiments from the scope of the disclosure, or from the scope of the claims.

1. The smoking substitute device according to claim 16,
wherein the removable cap comprises a first opening substantially parallel to the longitudinal extension of the heating element; and
wherein, when the removable cap is detached from the smoking substitute device, or the removable cap is reattached to the smoking substitute device, the heating element at least partially transitions through the first opening.

2. The smoking substitute device according to claim 16,
wherein the removable cap comprises a second opening, and
wherein the second opening at least partially corresponds to the shape of the radial cross section of the heating element, and
wherein, when the removable cap is detached from the smoking substitute device, or the removable cap is reattached to the smoking substitute device, the heating element at least partially transitions through the second opening.

3. The smoking substitute device according to claim 2,
wherein at least one of the first opening and the second opening, when the removable cap is detached from the smoking substitute device, or the removable cap is reattached to the smoking substitute device, at least partially move adjacent the heating element, so that debris, dirt and/or deposits are removed from the heating element.

4. (canceled)

5. The smoking substitute device according to claim 16,
wherein the first direction is a direction substantially parallel to the longitudinal axis of the smoking substitute device; and/or
wherein the second direction is a direction substantially parallel to the radial axis of the smoking substitute device; and in particular
wherein the first direction and the second direction are substantially perpendicular to one another.

6. The smoking substitute device according to claim 16,
wherein the body comprises an outer wall for substantially closing the first opening in the attached state.

7. The smoking substitute device according to claim 16,
wherein the first opening is adapted for cleaning the heating element and/or removing debris, dirt or deposits from the cavity when removed from the smoking substitute device, in particular
wherein cleaning the heating element comprises removing debris, dirt or deposits from the heating element surface.

8. The smoking substitute device according to claim 16, further comprising
a locking element for locking the removable cap to the body during operation;
wherein the locking element in particular is arranged to be unlockable by a user of the smoking substitute device for removal of the removable cap;
wherein further in particular the locking element is arranged so that the second opening is engageable with the heating element, and/or is arranged as an elevation in the housing, in particular the outer wall, wherein the elevation is engageable with the first opening.

9. The smoking substitute device according to claim 16, further comprising
a guide system for guiding a close-by movement of at least one of the first opening and the second opening relative to the heating element for scraping off debris, dirt or deposits from the heating element.

10. (canceled)

11. A method for cleaning of a smoking substitute device, the smoking substitute device comprising
a body having a longitudinal extension;
a cavity, arranged at an end of the body, for receiving an aerosol-generating consumable;
a heating element arranged in the cavity and having a longitudinal extension substantially parallel to the longitudinal extension of the body; and
a removable cap covering the end of the body at which the cavity is arranged;
the method comprising
moving the removable cap in a first direction; and
subsequently moving the removable cap in a second direction,
wherein the second direction is in particular substantially perpendicular to the first direction;
wherein, by the movement of the removable cap in a combination of the second direction and the first direction, the heating element is cleaned.

12. The method according to claim 11,
wherein cleaning the heating element comprises removing debris, dirt or deposits from the heating element surface.

13. The method according to claim 11,
the removable cap further comprises a first opening substantially parallel to the longitudinal extension of the heating element;
wherein, when the removable cap is detached from the smoking substitute device, or the removable cap is reattached to the smoking substitute device, the heating element at least partially transitions through the first opening.

14. The method of claim 13,
wherein the first opening, when the removable cap is detached from the smoking substitute device or the removable cap is reattached to the smoking substitute device, at least partially moves adjacent the heating element, so that debris, dirt and/or deposits are removed from the heating element.

15. The method of claim 14,
the removable cap further comprises a second opening at least partially corresponding to the shape of the radial cross section of the heating element;
wherein the second opening, when the removable cap is detached from the smoking substitute device or the removable cap is reattached to the smoking substitute device, is at least partially moving adjacent the heating element, so that debris, dirt and/or deposits are removed from the heating element

16. A smoking substitute device, comprising
a body having a longitudinal extension;
a cavity, arranged at an end of the body, for receiving an aerosol-generating consumable;
a heating element arranged in the cavity and having a longitudinal extension substantially parallel to the longitudinal extension of the body; and
a removable cap covering the end of the body where the cavity is arranged;
wherein, for detaching the removable cap from the smoking substitute device, the removable cap is arranged to be moved in a first direction and subsequently moved in a second direction, in particular substantially perpendicular to the first direction, and/or
wherein, for reattaching the removable cap to the smoking substitute device, the removable cap is arranged to be moved in a second direction and subsequently moved in a first direction, in particular substantially perpendicular to the second direction.
